(19) United States
(12) Patent Application Publication
(10) Pub. No.: US 2025/0347712 A1
(43) Pub. Date: Nov. 13, 2025

(54) EVENT DETECTION APPARATUS AND METHOD

(71) Applicant: HTC Corporation, Taoyuan City (TW)

(72) Inventors: Chao-Shuan HUANG, Taoyuan City (TW); Yen Cheng CHEN, Taoyuan City (TW)

(21) Appl. No.: 19/203,192

(22) Filed: May 9, 2025

Related U.S. Application Data
(60) Provisional application No. 63/645,963, filed on May 13, 2024.

(51) Int. Cl. G01P 13/00; G01P 3/36

(52) U.S. Cl. CPC G01P 13/00; G01P 3/36

(57) ABSTRACT

An event detection apparatus and method are provided. The apparatus is configured to detect an inertial signal and a first signal corresponding to the apparatus. The apparatus compares the first signal and multiple signal features to determine whether the first signal matches one of the signal features. In response to the first signal at a time point matching a first feature of the signal features, the apparatus determines whether the inertial signal during a time period matches a second feature. In response to the inertial signal during the time period matching the second feature, the apparatus triggers an event corresponding to the first feature and the second feature.

### CROSS-REFERENCE TO RELATED APPLICATION

This application claims priority to U.S. Provisional Application Ser. No. 63/645,963, filed May 13, 2024, which is herein incorporated by reference in its entirety.

### BACKGROUND

### Field of Invention

The present disclosure relates to an event detection apparatus and method. More particularly, the present disclosure relates to an event detection apparatus and method based on multiple sensors.

### Description of Related Art

In the technical field of object tracking, in order to detect various events triggered on an object, it is necessary to set up multiple different sensors to detect the status of different components on the object.

Taking a handgun as an example, in order to detect the user's operation of the handgun, sensors need to be installed on components such as the trigger, slide, safety, and magazine to determine the movement, position, force, and other statuses of the components.

However, setting up multiple sensors for different components will significantly increase the tracking cost.

In view of this, how to provide an event detection technology with lower cost and better efficiency is the goal that the industry strives to work on.

### SUMMARY

The disclosure provides an event detection apparatus comprising an inertial measurement unit, a first sensor, and a processor. The inertial measurement unit is configured to detect an inertial signal corresponding to the event detection apparatus. The first sensor is configured to detect a first signal corresponding to the event detection apparatus. The processor is electrically connected to the inertial measurement unit and the first sensor and configured to execute the following operations: comparing the first signal and a plurality of signal features to determine whether the first signal matches one of the signal features; in response to the first signal at a first time point matching a first feature of the signal features, determining whether the inertial signal during a time period matches a second feature, wherein the time period corresponding to the first time point; and in response to the inertial signal during the time period matching the second feature, triggering a first event corresponding to the first feature and the second feature.

The disclosure further provides an event detection method, being adapted for use in an electronic apparatus, wherein the electronic apparatus comprises an inertial measurement unit and a first sensor, the inertial measurement unit is configured to detect an inertial signal corresponding to the electronic apparatus, the first sensor is configured to detect a first signal corresponding to the electronic apparatus, and the event detection method comprises the following steps: comparing the first signal and a plurality of signal features to determine whether the first signal matches one of the signal features; in response to the first signal at a first time point matching a first feature of the signal features, determining whether the inertial signal during a time period matches a second feature, wherein the time period corresponding to the first time point; and in response to the inertial signal during the time period matching the second feature, triggering a first event corresponding to the first feature and the second feature.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an event detection apparatus according to a first embodiment of the present disclosure.

FIG. 2 is a schematic diagram illustrating a handgun as the event detection apparatus according to some embodiments of the present disclosure.

FIG. 3 is a schematic diagram illustrating a signal generated by a force sensor according to some embodiments of the present disclosure.

FIG. 4 is a schematic diagram illustrating inertial signals generated by an inertial measurement unit according to some embodiments of the present disclosure.

FIGS. 5A and 5B are schematic diagrams illustrating optical signals generated by an optical sensor according to some embodiments of the present disclosure.

FIG. 6 is a flow diagram illustrating an event detection method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

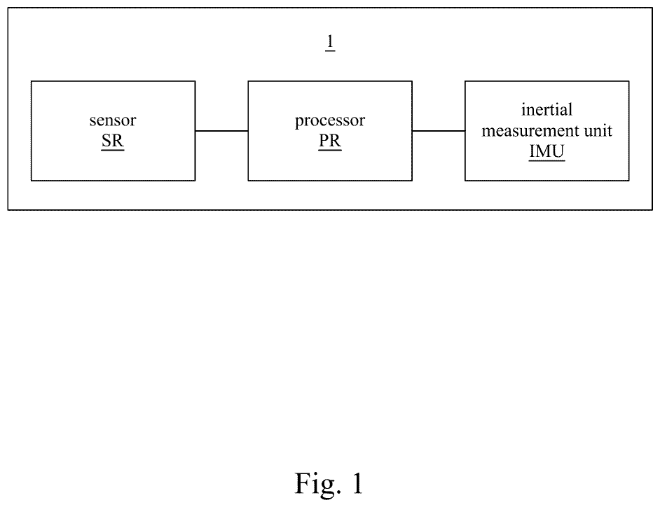

Please refer to FIG. 1, which is a schematic diagram illustrating an event detection apparatus 1 according to a first embodiment of the present disclosure. The event detection apparatus 1 comprises a processor PR, a sensor SR, and an inertial measurement unit IMU, wherein the processor PR is electrically connected to the sensor SR and the inertial measurement unit IMU. The event detection apparatus 1 is configured to detect the state of its own components.

The inertial measurement unit IMU is configured to detect the inertial signal corresponding to the event detection apparatus 1. For example, the inertial measurement unit IMU comprises a gyroscope and an accelerometer placed near the center of gravity of the event detection apparatus 1 and configured to detect the angular velocity and/or acceleration of the event detection apparatus 1.

The sensor SR is configured to detect the signal corresponding to the event detection apparatus 1. The type of the sensor SR can be determined according to the needs. For example, the sensor SR comprises a force sensor configured to detect force, a temperature sensor configured to detect temperature, an optical sensor configured to detect lights, and/or other suitable sensor.

The processor PR is configured to determine the state of the event detection apparatus 1 and execute the corresponding operations based on signals obtained from the sensor SR and the inertial measurement unit IMU. In some embodiments, the processor PR comprises a central processing unit (CPU), a graphics processing unit (GPU), a microcontroller unit (MCU), a multi-processor, a distributed processing system, an application specific integrated circuit (ASIC), and/or a suitable processing unit.

While the event detection apparatus 1 is operating, external forces (e.g., operations from the user) may cause changes in the signals detected by the sensor SR and/or the inertial measurement unit IMU. More specifically, when the event detection apparatus 1 receives certain operations or be in certain state, the signals detected by the sensor SR and/or the inertial measurement unit IMU will change correspondingly.

In accordance, in order to determine the state of the event detection apparatus 1, the processor PR compares whether the inertial signal obtained by the inertial measurement unit IMU and the signal obtained by the sensor SR match certain features, wherein different signal features represent different state of the event detection apparatus 1. By cross comparing the signal feature of each of the signals and obtaining the timing relationship between the signal features, the processor PR is able to determine if the event detection apparatus 1 receives certain operations or be in certain state, thereby executing the corresponding operation and/or triggering the corresponding event.

Specifically, the processor PR executes the following operations: comparing the first signal and a plurality of signal features to determine whether the first signal matches one of the signal features; in response to the first signal at a first time point matching a first feature of the signal features, determining whether the inertial signal during a time period matches a second feature, wherein the time period corresponding to the first time point; and in response to the inertial signal during the time period matching the second feature, triggering a first event corresponding to the first feature and the second feature.

Through comparison of two or more signals, in addition to detecting state changes in multiple aspects, the combination of multiple signal features may also present more types of state changes. Accordingly, the event detection apparatus 1 does not need to arrange sensors on each of the components to be detected and is able to determine the states such as movement, position, force of the components by utilizing limited signal sources and different combinations of signal features.

In some embodiments, the sensor SR is arranged on the component to be detected of the event detection apparatus 1 to measure the corresponding signal.

Specifically, the event detection apparatus 1 further comprises a first component, wherein the first sensor is arranged on the first component, and the first sensor is configured to detect a position of the first component to generate the first signal.

On the other hand, in order to measure the inertial signal of the whole event detection apparatus 1, the inertial measurement unit IMU is arranged on the center of gravity of the event detection apparatus 1 or other suitable location.

Specifically, the event detection apparatus 1 further comprises a second component, wherein the inertial measurement unit is arranged on the second component, and the second component is different from the first component.

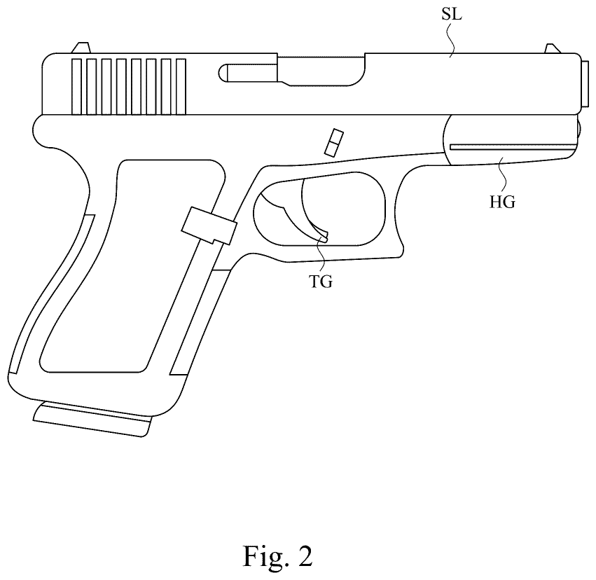

About the embodiment of the event detection apparatus 1, please refer to FIG. 2, which is a schematic diagram illustrating a handgun HG as the event detection apparatus 1 according to some embodiments of the present disclosure.

In order to track the operation on the handgun HG by the user, an inertial measurement unit IMU is arranged on the center of gravity of the handgun HG to detect the vibrations of the handgun HG while shooting. Additionally, a force sensor SR is arranged on a trigger TG of the handgun HG to detect the degree of the trigger TG being pulled. The processor PR can be arranged at suitable location depending on needs.

In some embodiments, the event detection apparatus 1 compares the signal feature of the signal measured by the force sensor SR to determine whether the user is pulling the trigger TG and firing the handgun HG.

Specifically, the signal features comprise a waveform feature, and the operation of the processor PR comparing the first signal and the signal features further comprises: comparing whether the first signal matches the waveform feature of the signal features.

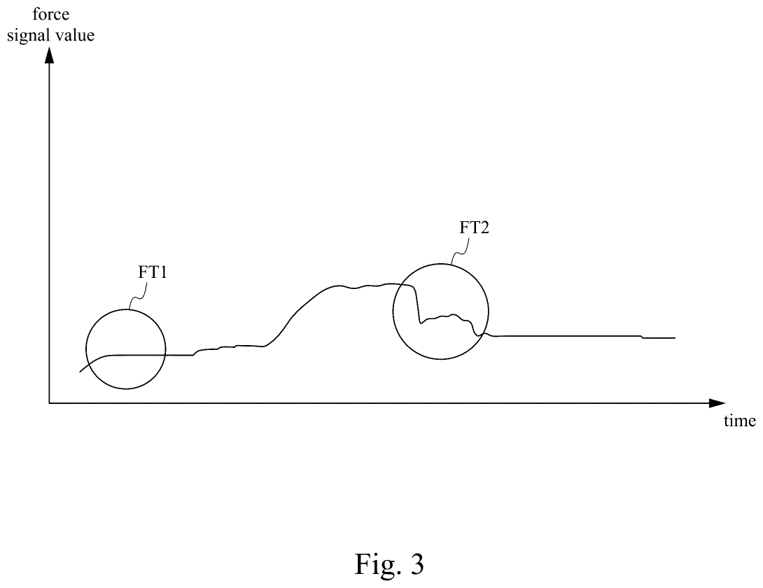

About the embodiment of the waveform features, please refer to FIG. 3, which is a schematic diagram illustrating a signal generated by the force sensor SR while the trigger TG is pulled according to some embodiments of the present disclosure. First, as shown in the area framed by the signal feature FT1, the signal measured by the force sensor SR shows a rising waveform while the trigger TG just being pulled. Afterwards, when the handgun HG fires, as shown in the area framed by the signal feature FT2, the signal measured by the force sensor SR shows a two-stage decent waveform.

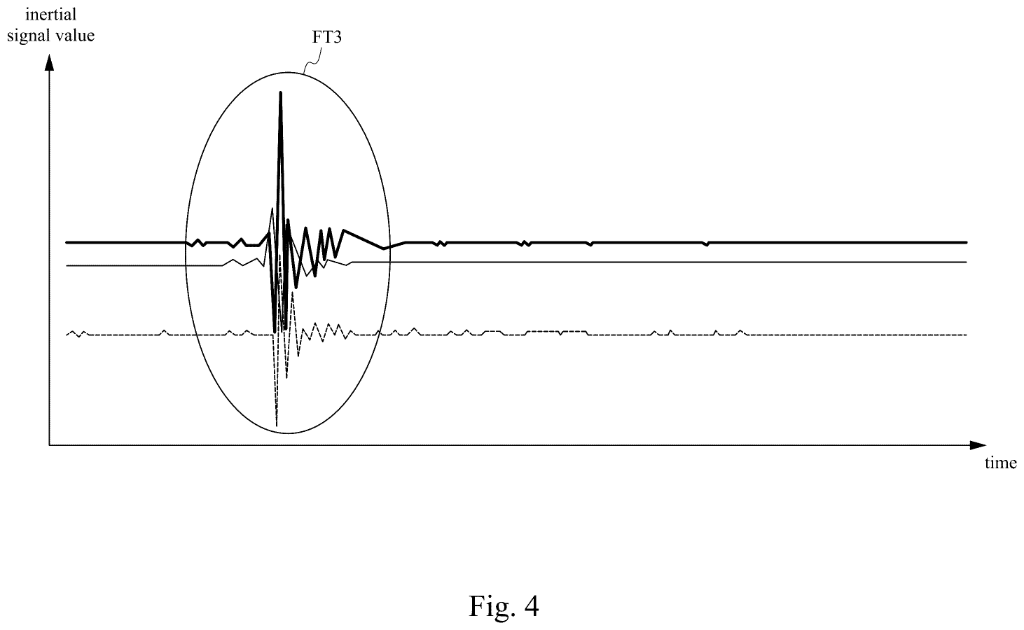

On the other hand, please refer to FIG. 4, which is a schematic diagram illustrating inertial signals generated by the inertial measurement unit IMU while the handgun HG is fired according to some embodiments of the present disclosure. As shown in the area framed by the signal feature FT3, when the handgun HG is fired, the acceleration signal measured by the inertial measurement unit IMU (i.e., the inertial signal) shows a waveform with significant fluctuations.

According to the characteristic, the event detection apparatus 1 may determine whether the inertial signal measured by the inertial measurement unit IMU is greater than a specific threshold. When the inertial signal is greater than the threshold, the event detection apparatus 1 determines that the inertial signal matches the signal feature FT3.

Specifically, the operation of the processor PR determining whether the inertial signal matches the second feature further comprises: in response to the inertial signal being greater than a signal threshold, determining that the inertial signal matches the second feature.

By combining the signal features FT1, FT2, and FT3 of two types of signals, the event detection apparatus 1 is able to determine whether the handgun HG is fired based on the timing characteristics of the signal features.

Specifically, the operation of the processor PR triggering the first event further comprises: determining whether the first signal during the time period matches a third feature; and in response to the first signal during the time period matching a third feature and the inertial signal during the time period matching the second feature, triggering the first event.

Taking FIGS. 2-4 as an example, in terms of timing, from the trigger TG being pulled to the handgun HG being fired, the signal measured by the force sensor SR will show the signal feature FT1 first while the trigger TG being pulled.

Next, when the handgun HG is fired, the signal measured by the force sensor SR will show the signal feature FT2 and the inertial signal measured by the inertial measurement unit IMU will show the signal feature FT3.

Correspondingly, after determining that the signal measured by the force sensor SR matches the signal feature FT1, the event detection apparatus 1 determines whether the signal measured by the force sensor SR matches the signal feature FT2 and whether the inertial signal measured by the inertial measurement unit IMU matches the signal feature FT3 in the subsequent time period (e.g., in the subsequent 1 second) in order to determine whether the handgun HG is fired.

By combining the signal features FT1, FT2, and FT3 and the timing relationship of the signal features, the event detection apparatus 1 is able to determine the time points of the trigger TG being pulled and the handgun HG being fired. In accordance, the event detection apparatus 1 may trigger the corresponding operation and/or event, e.g., recording number of shots, transmitting notification signal to other apparatus, etc.

Furthermore, in some embodiments, since the firing time of the handgun HG is short, the signal features FT2 and FT3 will occur simultaneously in a short period of time. Therefore, in order to avoid misjudgment, the event detection apparatus 1 also confirm whether the handgun HG is fired based on the timing relationship between the signal features FT2 and FT3.

Specifically, the operation of the processor PR triggering the first event further comprises: calculating a time difference between a second time point corresponding to the second feature in the inertial signal and a third time point corresponding to the third feature in the first signal; and in response to the time difference being lower than a time threshold, triggering the first event.

For example, after determining that the signal measured by the force sensor SR matches the signal feature FT2 and the inertial signal measured by the inertial measurement unit IMU matches the signal feature FT3, the event detection apparatus 1 further determines whether the time difference between the signal features FT2 and FT3 is less than a certain value (e.g., 50 milliseconds). If the time difference is less than the certain value, the event detection apparatus 1 confirms that the handgun HG has been fired and triggers.

In some embodiments, the sensor SR may be an optical sensor, and the event detection apparatus 1 determines whether to trigger the corresponding operation and/or event based on the optical signal measured by the optical sensor SR.

Specifically, the signal features comprise an optical feature, and the operation of the processor PR comparing the first signal and the signal features further comprises: comparing whether the first signal matches the optical feature of the signal features.

When the handgun HG is fired, the slide SL will move back and forth. However, if the magazine is empty and no bullets are loaded into the chamber, the slide SL will not slide forward and be locked to the rear.

In some embodiments, the event detection apparatus 1 utilizes the aforementioned characteristic, and an optical sensor is arranged on the slide SL (not shown in the figure). Through monitoring reference points on the slide SL by the optical sensor, the event detection apparatus 1 may detect whether the slide SL is locked to the rear after the handgun HG is fired.

Specifically, the event detection apparatus further comprises a third component and an optical sensor. The third component has a plurality of reference points. The optical sensor is electrically connected to the processor PR and configured to detect an optical signal corresponding to the reference points. The processor PR is further configured to execute the following operations: calculating a displacement state of the third component based on the optical signal; and in response to the displacement state of the third component meeting a displacement condition, and the inertial signal during the time period matching the second feature, triggering a second event corresponding to the displacement condition and the second feature.

Furthermore, the event detection apparatus 1 calculates a light spot distance corresponding to the reference points from the optical signal to determine the displacement state of the slide SL.

Specifically, the operation of the processor PR calculating a displacement state of the third component further comprising: calculating a distance between a plurality of light spot corresponding to the reference points based on the optical signal; and determining the displacement state of the third component based on the distance and a plurality of reference distances.

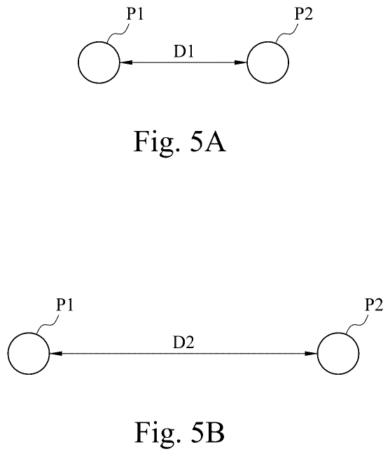

Please refer to FIGS. 5A and 5B, which are schematic diagrams illustrating optical signals generated by an optical sensor according to some embodiments of the present disclosure. In the embodiment, the optical sensor is arranged behind the slide SL to monitor two reference points (e.g., two infrared transmitters) at the rear of the slide SL.

Accordingly, as shown in FIG. 5A, when the slide SL slides to the front, the optical sensor monitors the reference points and generates two light spots P1 and P2, and there is a distance D1 between the light spots P1 and P2. On the other hand, when the slide SL slides back and is locked, there is a distance D2 between the light spots P1 and P2.

Since the reference points are relatively far from the optical sensor when the slide SL slides to the front, and the reference points are relatively near from the optical sensor when the slide SL is locked at the rear, the distance D1 is shorter than the distance D2 between the light spots P1 and P2. Accordingly, through combining the aforementioned embodiments, the event detection apparatus 1 is able to determine whether the slide SL is locked at the rear after the handgun HG is fired based on the distance between the light spots P1 and P2. If the slide SL is locked at the rear after the handgun HG is fired, the event detection apparatus 1 is able to estimate that there are no bullets in the handgun HG and the magazine, thereby triggering the corresponding operation and/or event (e.g., notifying the user to change the magazine).

As a result, it is not necessary to arrange sensors in the magazine or chamber, and the event detection apparatus 1 is able to determine that there are no bullets in the magazine and/or chamber based on the signals from the optical sensor, the sensor SR, and/or the inertial measurement unit IMU. Additionally, the sensors on the slide SL and the trigger TG may also be configured to determine other states of the handgun HG (e.g., jammed).

It is noted that, the aforementioned embodiment takes infrared transmitters as an example of the reference points. However, the present disclosure is not limited thereto. In other embodiments, the reference points may be identifiers arranged on the component and can be visually or optically identified, e.g., marks and/or raised dots on the surface of the component.

In summary, the event detection apparatus 1 provided by the present disclosure compares features and/or timing relationship between multiple signals based on the sensors on the existing components (e.g., slide, trigger) to estimate the operating states of other components (e.g., chamber, magazine). As a result, the event detection apparatus 1 may reduce the number of the sensors and the computational burden of signals and has the advantages of lower cost and better efficiency.

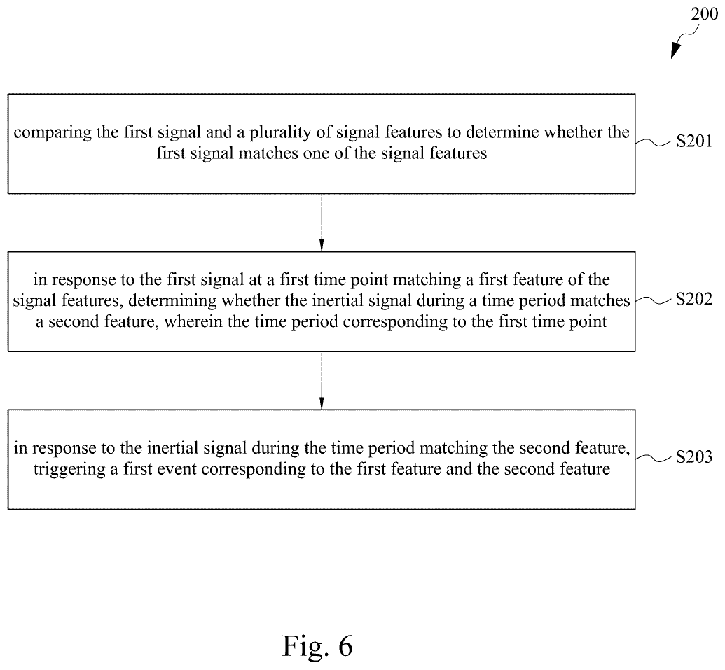

Please refer to FIG. 6, which is a flow diagram illustrating an event detection method 200 according to a second embodiment of the present disclosure. The event detection method 200 comprises steps S201-S203. The event detection method 200 is configured to is a flow diagram illustrating an event detection method according to a second embodiment of the present disclosure. The event detection method 200 can be executed by an electronic apparatus (e.g., the event detection apparatus 1 in the first embodiment). The electronic apparatus comprises an inertial measurement unit and a first sensor, the inertial measurement unit is configured to detect an inertial signal corresponding to the electronic apparatus, the first sensor is configured to detect a first signal corresponding to the electronic apparatus.

First, in the step S201, the electronic apparatus compares the first signal and a plurality of signal features to determine whether the first signal matches one of the signal features.

Next, in the step S202, in response to the first signal at a first time point matching a first feature of the signal features, the electronic apparatus determines whether the inertial signal during a time period matches a second feature, wherein the time period corresponding to the first time point.

Finally, in the step S203, in response to the inertial signal during the time period matching the second feature, the electronic apparatus triggers a first event corresponding to the first feature and the second feature.

In some embodiments, the step S201 further comprises the electronic apparatus comparing whether the first signal matches the waveform feature of the signal features.

In some embodiments, the step S201 further comprises the electronic apparatus comparing whether the first signal matches the optical feature of the signal features.

In some embodiments, the step S202 further comprises in response to the inertial signal being greater than a signal threshold, the electronic apparatus determining that the inertial signal matches the second feature.

In some embodiments, the step S203 further comprises the electronic apparatus determining whether the first signal during the time period matches a third feature; and in response to the first signal during the time period matching a third feature and the inertial signal during the time period matching the second feature, the electronic apparatus triggering the first event.

In some embodiments, the step S203 further comprises the electronic apparatus calculating a time difference between a second time point corresponding to the second feature in the inertial signal and a third time point corresponding to the third feature in the first signal; and in response to the time difference being lower than a time threshold, the electronic apparatus triggering the first event.

In some embodiments, the electronic apparatus further comprises a first component, the first sensor is arranged on the first component, and the first sensor is configured to detect a position of the first component to generate the first signal.

In some embodiments, the electronic apparatus further comprises a second component, the inertial measurement unit is arranged on the second component, and the second component is different from the first component.

In some embodiments, the electronic apparatus further comprises a third component and an optical sensor, the third component has a plurality of reference points, the optical sensor is configured to detect an optical signal corresponding to the reference points, and the event detection method 200 further comprises the electronic apparatus calculating a displacement state of the third component based on the optical signal; and in response to the displacement state of the third component meeting a displacement condition, and the inertial signal during the time period matching the second feature, the electronic apparatus triggering a second event corresponding to the displacement condition and the second feature.

In some embodiments, the step of calculating a displacement state of the third component further comprises the electronic apparatus calculating a distance between a plurality of light spot corresponding to the reference points based on the optical signal; and the electronic apparatus determining the displacement state of the third component based on the distance and a plurality of reference distances.

In summary, the event detection method 200 provided by the present disclosure compares features and/or timing relationship between multiple signals based on the sensors on the existing components (e.g., slide, trigger) to estimate the operating states of other components (e.g., chamber, magazine). As a result, the event detection method 200 may reduce the number of the sensors and the computational burden of signals and has the advantages of lower cost and better efficiency.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An event detection apparatus, comprising:
an inertial measurement unit, configured to detect an inertial signal corresponding to the event detection apparatus;
a first sensor, configured to detect a first signal corresponding to the event detection apparatus; and
a processor, electrically connected to the inertial measurement unit and the first sensor, configured to execute the following operations:
comparing the first signal and a plurality of signal features to determine whether the first signal matches one of the signal features;
in response to the first signal at a first time point matching a first feature of the signal features, determining whether the inertial signal during a time period matches a second feature, wherein the time period corresponding to the first time point; and
in response to the inertial signal during the time period matching the second feature, triggering a first event corresponding to the first feature and the second feature.

2. The event detection apparatus of claim 1, wherein the signal features comprise a waveform feature, and the operation of comparing the first signal and the signal features further comprises:
comparing whether the first signal matches the waveform feature of the signal features.

3. The event detection apparatus of claim 1, wherein the signal features comprise an optical feature, and the operation of comparing the first signal and the signal features further comprises:
comparing whether the first signal matches the optical feature of the signal features.

4. The event detection apparatus of claim 1, wherein the operation of determining whether the inertial signal matches the second feature further comprises:
in response to the inertial signal being greater than a signal threshold, determining that the inertial signal matches the second feature.

5. The event detection apparatus of claim 1, wherein the operation of triggering the first event further comprises:
determining whether the first signal during the time period matches a third feature; and
in response to the first signal during the time period matching a third feature and the inertial signal during the time period matching the second feature, triggering the first event.

6. The event detection apparatus of claim 5, wherein the operation of triggering the first event further comprises:
calculating a time difference between a second time point corresponding to the second feature in the inertial signal and a third time point corresponding to the third feature in the first signal; and
in response to the time difference being lower than a time threshold, triggering the first event.

7. The event detection apparatus of claim 1, further comprising:
a first component, wherein the first sensor is arranged on the first component, and the first sensor is configured to detect a position of the first component to generate the first signal.

8. The event detection apparatus of claim 7, further comprising:
a second component, wherein the inertial measurement unit is arranged on the second component, and the second component is different from the first component.

9. The event detection apparatus of claim 1, further comprising:
a third component, having a plurality of reference points; and
an optical sensor, electrically connected to the processor, configured to detect an optical signal corresponding to the reference points;
wherein the processor is further configured to execute the following operations:
calculating a displacement state of the third component based on the optical signal; and
in response to the displacement state of the third component meeting a displacement condition, and the inertial signal during the time period matching the second feature, triggering a second event corresponding to the displacement condition and the second feature.

10. The event detection apparatus of claim 9, wherein the operation of calculating a displacement state of the third component further comprises:
calculating a distance between a plurality of light spot corresponding to the reference points based on the optical signal; and
determining the displacement state of the third component based on the distance and a plurality of reference distances.

11. An event detection method, being adapted for use in an electronic apparatus, wherein the electronic apparatus comprises an inertial measurement unit and a first sensor, the inertial measurement unit is configured to detect an inertial signal corresponding to the electronic apparatus, the first sensor is configured to detect a first signal corresponding to the electronic apparatus, and the event detection method comprises the following steps:
comparing the first signal and a plurality of signal features to determine whether the first signal matches one of the signal features;
in response to the first signal at a first time point matching a first feature of the signal features, determining whether the inertial signal during a time period matches a second feature, wherein the time period corresponding to the first time point; and
in response to the inertial signal during the time period matching the second feature, triggering a first event corresponding to the first feature and the second feature.

12. The event detection method of claim 11, wherein the signal features comprise a waveform feature, and the step of comparing the first signal and the signal features further comprises:
comparing whether the first signal matches the waveform feature of the signal features.

13. The event detection method of claim 11, wherein the signal features comprise an optical feature, and the step of comparing the first signal and the signal features further comprises:
comparing whether the first signal matches the optical feature of the signal features.

14. The event detection method of claim 11, wherein the step of determining whether the inertial signal matches the second feature further comprises:
in response to the inertial signal being greater than a signal threshold, determining that the inertial signal matches the second feature.

15. The event detection method of claim 11, wherein the step of triggering the first event further comprises:
determining whether the first signal during the time period matches a third feature; and
in response to the first signal during the time period matching a third feature and the inertial signal during the time period matching the second feature, triggering the first event.

16. The event detection method of claim 15, wherein the step of triggering the first event further comprises:
calculating a time difference between a second time point corresponding to the second feature in the inertial signal and a third time point corresponding to the third feature in the first signal; and
in response to the time difference being lower than a time threshold, triggering the first event.

17. The event detection method of claim 11, wherein the electronic apparatus further comprises a first component, the first sensor is arranged on the first component, and the first sensor is configured to detect a position of the first component to generate the first signal.

18. The event detection method of claim 17, wherein the electronic apparatus further comprises a second component, the inertial measurement unit is arranged on the second component, and the second component is different from the first component.

19. The event detection method of claim 11, wherein the electronic apparatus further comprises a third component and an optical sensor, the third component has a plurality of reference points, the optical sensor is configured to detect an optical signal corresponding to the reference points, and the event detection method further comprises:
calculating a displacement state of the third component based on the optical signal; and
in response to the displacement state of the third component meeting a displacement condition, and the inertial signal during the time period matching the second feature, triggering a second event corresponding to the displacement condition and the second feature.

20. The event detection method of claim 19, wherein the step of calculating a displacement state of the third component further comprises:
calculating a distance between a plurality of light spot corresponding to the reference points based on the optical signal; and
determining the displacement state of the third component based on the distance and a plurality of reference distances.
